(19) United States
(12) Patent Application Publication
(10) Pub. No.: US 2024/0384174 A1
(43) Pub. Date: Nov. 21, 2024

(54) PROCESS TO CONVERT A SOLID BIOMASS TO A CRUDE FUEL

(71) Applicant: Raymond Paul FLETCHER, Amsterdam (NL)

(72) Inventor: Raymond Paul FLETCHER, Amsterdam (NL)

(21) Appl. No.: 18/667,351

(22) Filed: May 17, 2024

Related U.S. Application Data
(60) Provisional application No. 63/467,066, filed on May 17, 2023.

(51) Int. Cl. C10B 53/02; B01D 3/14; C10B 7/10; C10B 49/10; C10L 1/04

(52) U.S. Cl. CPC C10B 53/02; B01D 3/14; C10B 7/10; C10B 49/10; C10L 1/04; C10L 2200/0438

(57) ABSTRACT

The invention is directed to a process to convert a solid biomass to a crude fuel comprising middle distillate fuel fractions, the process comprising: (a) contacting the solid biomass having a water content of below 20 wt % with steam for more than 10 seconds at pressurised conditions to obtain steam saturated biomass and (b) subjecting the steam saturated biomass to a pyrolysis step at a temperature of between 600 and 800° C. to obtain the crude fuel comprising the middle distillate fuel fractions.

### CROSS-REFERENCE TO RELATED APPLICATIONS

This application claims benefit under 35 U.S.C. § 119 (e) of U.S. Provisional Application No. 63/467,066 filed May 17, 2023, the contents of which are incorporated herein by reference in their entirety.

### TECHNICAL FIELD

The present invention is directed to a process to convert a solid biomass to a crude fuel comprising middle distillate fractions by performing a pyrolysis step.

### BACKGROUND

WO91/11499 describes in its introductory part that historically pyrolysis of carbonaceous materials was performed by so called slow pyrolysis which yielded roughly equal proportions of non-reactive solids, like char and ash, liquid products and non-condensable gases. It was found that fast pyrolysis yielded more valuable chemicals and fuels at the expense of the undesirable slow pyrolysis products. The fast pyrolysis is described to take place at a temperature between 350 and 800 C at a solids residence time of between 30 ms to 2 seconds. The reaction products are reduced to a temperature below 350° C. within 0.5 seconds. Various reactors are described such as a fluidised bed reactor. It is mentioned that in such a reactor the short solid residence time for fast pyrolysis cannot be achieved. Vacuum pyrolysis is mentioned as advantageous to achieve a high liquid products yield. However vacuum pyrolysis is described to be disadvantageous because of heat transfer limitations, difficulty associated with scale up of vacuum processes and the potential of inadequate solids flow. The proposed process of this publication involves a vertical entrained bed transport reactor where the solid carbonaceous feed contacts a recirculating solid heat carrier. The recirculating heat carrier is isolated from the reaction products and separately reheated before being contacted with fresh feedstock.

More recent publications like for example WO2012/115754 describe a similar fast pyrolysis process involving a circulating heat carrier, which may be sand particles. The illustrated process involves a reheater where pyrolysis char is combusted to directly heat the heat carrier.

US2019/0153324 describes a pyrolysis process as performed in the presence of a fluidized catalyst, such as a sulphided cobalt-molybdenum catalyst and in the presence of a hydrogen containing gas. A disadvantage of this process is the use of a sulphided catalyst. For one the catalyst requires to be sulphided in a separate reactor. Further the catalyst requires metals which make the catalyst complex when compared to a typical FCC catalyst. Further the metals may end up in the gas oil product and fresh catalyst is required to be added in larger quantities to compensate for the loss of catalyst.

WO22063926 describes a pyrolysis of a biomass having a moisture content of less than 10 wt % at a temperature of at least 950 C.

A disadvantage of such a process is that the yield to middle distillate fuels, such as kerosene and gas oil, is relatively low.

### SUMMARY

It is the object of the present invention is to provide a process having a higher yield to these middle distillate fuels when starting from a biomass feedstock.

### DETAILED DESCRIPTION

This object is achieve by the following process. Process to convert a solid biomass to a crude fuel comprising middle distillate fuel fractions by performing the following steps:
(a) contacting the solid biomass having a water content of below 20 wt % with steam for more than 10 seconds at pressurised conditions to obtain steam saturated biomass and
(b) subjecting the steam saturated biomass to a pyrolysis step at a temperature of between 600 and 800° C. to obtain the crude fuel comprising the middle distillate fuel fractions.

Applicants found that with this process a significant higher yield to middle distillate fuel fractions as part of the crude fuel may be obtained via the incorporation of an autohydrolysis reactor prior to the pyrolysis reaction. This reactor has the dual effect of 1) initiating the autohydrolysis reaction within the biomass which weakens the hemicellulose structure, and 2) infusing excess water within the biomass prior to entering the pyrolysis reactor.

Without wishing to be bound to the following theory applicants believe that the steam in step (a) functions as a catalyst that can penetrate via the fractures, faults, and cracks in the biomass cell walls and initiate the autohydrolysis reaction. These fractures are formed during a drying process to achieve the low water content. There exists a strong osmotic driving force for water to enter the dried out and shrivelled biomass cells. By subjecting the steam saturated biomass to the high temperature pyrolysis of step (b) the cells of the biomass are more easily fractured resulting in a higher yield to the desired middle distillate fractions.

A narrow particle size distribution (PSD) coupled with a small average particle size of the biomass entering the pyrolysis reactor ensures that the transfer of heat into the core of the wood particles is extremely rapid. This water forced into the biomass cellular structure when injected into the high temperature within the pyrolysis reactor evaporates explosively within the cellular structure of the previously dried biomass. It is found that injection of steam into the biomass resulted in a significant increase in liquid fuel. It is believed that the thermally driven steam explosion predominantly ruptures the hemicellulose portion of the biomass as evidenced by the increase of the fuel boiling in the diesel and kerosine fractions of the liquid fuel, by the significant reduction in high boiling residue molecules boiling over 1000° F. (538° C.), and by the type of molecules observed in the fuel as measured by Gas Chromatography Mass Spectrometry (GC-MS) such as glucuronoxylan, arabinoxylan, glucomannan, xyloglucan, and xylan.

The biomass source may be any biomass, provided the water content is low. The biomass material may be any material comprising cellulose, hemicellulose and lignin including virgin biomass and waste biomass. Virgin biomass includes all naturally occurring terrestrial plants such as trees, i.e. wood, bushes and grass. Waste biomass is produced as a low value by-product of various industrial sectors such as the agricultural and forestry sector. Examples of agriculture waste biomass are com stover, sugarcane bagasse, beet pulp, rice straw, rice hulls, barley straw, corn cobs, wheat straw, canola straw, rice straw, oat straw, oat hulls and corn fibre. A specific example is palm oil waste such as oil palm fronds (OPF), roots and trunks and the by-products obtained at the palm oil mill, such as for example empty fruit bunches (EFB), fruit fibers, kernel shells, palm oil mill effluent and palm kernel cake. For urban areas, the best potential plant biomass feedstock includes yard waste (e.g., grass clippings, leaves, tree clippings, and brush) and vegetable processing waste. Waste biomass may also be Specified Recovered Fuel (SRF) comprising lignocellulose.

Preferably the biomass is a woody biomass. As used herein “woody” refers to biomass that comprises wood or wood products. The woody biomass may be particles of wood, forestry residues, any type of wood, for example palm fronds, cedar, mesquite, oak, spruce, poplar, willow, and bamboo, wood harvesting residue, like for example limbs, stumps and roots, wood waste, cardboard, construction debris, demolition debris, used pallets, furniture waste and municipal waste.

The size of the carbonaceous particles may be expressed in its largest and smallest dimension. Preferably more than 85 wt % and even more preferably more than 90 wt % of the particles have a largest dimension of smaller than 2 cm and preferably smaller than 1.5 cm and more preferably smaller than 1 cm. The smallest dimension may be 0.1 cm. Larger particles require higher severity which leads to more undesired cracking in step (b).

The particles may be saw dust, shavings, chips, pellets, such as wood chips and/or wood pellets.

The solid biomass has a water content of below 20 wt % and preferably below 10 wt % and even more preferably below 10 wt %. The dried solid biomass suitably has a water content of more than 5 wt %. Reducing the water content to below 5 wt % is technically possible but found not necessary to achieve the desired results. The dried biomass and especially the dried woody biomass will have cracks as formed in the drying process. As typical non-dried wood may have a water content of around 40 wt % or higher, drying may be required as a pre-treating step. The required heat for drying may be obtained by indirect heat exchange against the products obtained in step (b).

In step (a) the solid biomass is contacted with steam. It is believed that the steam has two functions namely 1) initiating autohydrolysis reactions (b) and 2) to force hot water into the dried cells of the biomass. The hot water entering the biomass causes the dried biomass cells rapidly absorb hot water into the cell interior which initiates autohydrolysis reactions which destroy the hemicellulose.

The steam may be super heated steam or saturated steam. Good results have been achieved with saturated steam. The steam may be low or medium pressure steam. Preferably the steam has a pressure of at least 0.031 MPa. Step (a) may be performed at near vacuum conditions and up to 1.4 MPa. The solid biomass is contacted with the steam for a time sufficient that the steam penetrates the cracks of the dried biomass. The contact time of solid biomass and steam in step (a) is greater than 10 seconds and preferably the contact time is between 0.5 and 30 minutes. Step (a) may be performed batch wise, semi-batch wise or continuously. When performed batch wise steam and biomass are contained in a reactor for the desired contact time. When performed semi-batch wise biomass is present in a reactor and steam is continuously or intermittently supplied to the container for the desired contact time. When performed continuously the biomass and steam are both continuously fed to a reactor and the obtained steam saturated biomass is continuously discharged from the reactor.

The steam saturated biomass as obtained in step (a) is suitably directly subjected to the pyrolysis conditions of step (b). By directly is meant that measures are taken to avoid that steam leaves the steam saturated biomass in a substantial manner. This may be achieved by keeping the residence time between step (a) and (b) as low as possible. Preferably the residence time between step (a) and (b) does not exceed 2 minutes. In step (b) the water absorbed into the biomass will rapidly increase in volume causing the hemicellulose bonding the lignin and cellulose to fail resulting in multiple “mini explosions” within the biomass. This will result in breaking apart the hemicellulose polysaccharides and shattering cell walls. Thus any steam leaving the steam saturated biomass before step (b) is performed will negatively influence the yield to the desired crude. Furthermore, heated walls and insulation maintain the steam in the vapor phase preventing condensation.

It is believed that the pyrolysis reaction of step (b) swiftly proceeds to thermally crack the cellulose, hemicellulose fragments, and lignin into liquid fuel and syngas. It is found that the oxygen present in the hemicellulose is predominantly converted to weak acids and other water-soluble compounds thereby reducing the oxygen content of the middle distillate fuel fractions to 5 wt % or less leading to improved fuel density. The fuel exiting the reactor is found to have a very high Total Acid Number (TAN) of greater than 30 mg KOH/g fuel.

Step (b) is performed in the absence of oxygen. In the absence of oxygen is suitably at an oxygen content of below 2500 ppm. Step (b) is preferably performed in the absence of added catalysts and more preferred in the absence of a heterogeneous catalyst as for example described in US2019/0153324 which are porous heterogeneous catalysts onto which one or more metals of Group 6, Group 9 or Group 10 of the Table of Elements are incorporated. In some embodiments, porous heterogeneous supported metal catalysts are not present in step (b). In some embodiments, porous heterogeneous supported metal catalysts are not present in step (a) or (b). In some embodiments, the solid biomass is not contacted with a porous heterogeneous supported metal catalyst. In some embodiments, the steam saturated biomass is not contacted with a porous heterogeneous supported metal catalyst. In some embodiments, neither the solid biomass nor the steam saturated biomass is contacted with a porous heterogeneous supported metal catalyst.

In step (b) the steam saturated biomass is suitably subjected to a temperature of above 600° C. for a period of at least 30 seconds. The temperature is preferably between 600° C. and even more preferably above 625° C. and even more preferably 650° C. or above. The temperature is preferably below 800° C. and more preferably below 700° C. Step (b) is preferably performed continuously. The residence time of the solids in a continuously operated step (b) is at least 30 seconds, preferably between 50 and 120 seconds and even more preferably between 60 and 120 seconds. It is found that the selectivity to gas oil and kerosene can be influenced by adapting the reaction conditions. The pressure at which the pyrolysis step (b) is performed may range from 0.7 to 35 kPa. It has been found that the best quality gas oil product is prepared when the pressure is near vacuum. Suitably the pressure is between 3.0 kPa and 15 kPa.

In step (b) a solid char and a crude fuel is obtained. The crude fuel is obtained in its gaseous form. The char particles are residual biomass particles having a reduced hydrogen over carbon ratio as compared to the starting biomass particles. The atomic hydrogen over carbon ratio of the char may be between 0.5 and 0.7. The char particles will be comprised of the inorganic compounds as originally present in the biomass and part of the carbon as originally present in the biomass. The relatively high hydrogen over carbon ratio makes the char suitable as feedstock for gasification processes to prepare synthesis gas and/or hydrogen.

Examples of reactor concepts to perform step (b) are the Fluidized bed pyrolysis reactor, Circulating fluidized pyrolysis bed reactor, Fixed bed pyrolysis reactor, Vacuum pyrolysis reactor, Ablative plate pyrolysis reactor, Augur screw pyrolysis reactor, Rotary kiln pyrolysis reactor, Drum pyrolysis reactor, Tubular pyrolysis reactor, Heinz retort pyrolysis reactor, Rotating cone pyrolysis reactor, Cyclone/vortex pyrolysis reactor and Entrained flow pyrolysis reactor.

The step (b) is suitably performed in an auger screw reactor, especially when the process is performed on a relatively small scale. This may be near the source of the biomass. This is advantageous because then the crude fuel only needs to be transported to a more centrally located refinery type installation instead of having to transport the more voluminous biomass. The process may be performed in a sequence of an augur screw reactor to perform step (a) fluidly connected to an auger screw pyrolysis reactor to perform step (b).

A preferred reactor is a fluidised bed reactor. Especially when the process is performed on a larger scale. The fluidised bed reactor suitably comprises a bubbling fluidising bed of the biomass particles to which fluidising bed a fluidising gas is supplied and from which fluidising bed a gaseous mixture is discharged upwardly and away from the fluidising bed. The gaseous mixture comprises the crude fuel comprising middle distillate fuel fractions. The fluidising particles will in a continuous process be a mixture of the biomass particles and char particles. Inert particles may be present, such as sand, acting as a heat carrier. The fluidising gas may comprise of nitrogen, methane, carbon dioxide, carbon monoxide. natural gas and hydrogen and their mixtures. The fluidising gas may be gas formed in step (b) of this invention. Preferably hydrogen is present for at least 25 vol. %. The hydrogen comprising gas will not comprise any measurable amounts of oxygen. Any oxygen ingress into the hydrogen comprising gas will almost immediately react with hydrogen at the elevated temperature conditions.

The fluidising gas is suitably supplied to the fluidising bed at a velocity of more than 0.25 m/s and preferably between 1 and 2 m/s. The fluidizing gas may contain hydrogen gas to be injected into the reactor. Preferably the gravitational force on the particles is in counterbalance with the drag force of the upwardly flowing gas. The gas velocity at which this happens is referred to as the incipient fluidization velocity. The process is thus preferably performed using a gas that is flowing just above the incipient fluidization velocity. In this way less of the particles are entrained with the gas. Any such entrained particles are preferably separated from the gaseous mixture which is discharged upwardly by means of one or more cyclones. Such cyclones may suitably be positioned in the upper part of such a vessel. In this way the separated particles can be easily returned to the fluidised bed of particles.

The fluidising gas may be supplied to the fluidised bed reactor via a perforated plate or a perforated dome and more preferably via a gas distribution pipe grid that extends across the cross-sectional area of the reactor. Such inlet systems are well known in the field of fluidisation.

The biomass particles may be supplied to the bubbling fluidised bed reactor via a supply conduit preferably by means of gravity and pressure. Preferably the supply of particles is performed continuously.

The char particles and the gaseous mixture are suitably separately discharged from the bubbling fluidised bed reactor. The gaseous mixture is suitably discharged at the upper end of the bubbling fluidised bed reactor, optionally via one or more cyclones. The char particles may be removed by discharging part of the fluidised particles from the bubbling fluidised bed. This may be achieved by for example a non-symmetrical collection hopper below an optional distribution grid to prevent bridging of the char or via an overflow well permanently fixed above the distribution grid in order to control bed depth. The overflow pipe may be in the shape of a non-symmetrical hopper.

The char particles as discharged are suitably cooled while being discharged and/or after discharge. Preferably the cooling is performed by means of an indirect heat exchange. Suitably the cooling medium is evaporating boiler feed water. Any entrained gasses are separated from the cooled char particles, suitably by means of a cyclone.

From the gaseous mixture any entrained particles are removed, preferably by means of a cyclone, preferably two cyclones in series. In a bubbling bed reactor more than one of such series of cyclones may be present and suspended from the roof of the reactor vessel. The hot gaseous mixture is preferably reduced in temperature by heat exchangers or by quenching. Preferably the quenching is performed by contacting the gaseous mixture with a liquid mixture of hydrocarbons having a lower temperature than the gaseous mixture resulting in a gaseous mixture reduced in temperature and a rich quench liquid. Part of the higher boiling compounds in the gaseous mixture will condense in the quenching step and become part of the rich quench liquid. The liquid mixture of hydrocarbons preferably has a boiling range boiling predominantly above the boiling range of the middle distillate fractions. The temperature of the liquid mixture of hydrocarbons to be used in the quenching step is suitably at least 150° C., preferably at least 300° C., lower than the temperature of the rich quench liquid.

The rich quench liquid is suitably reduced in temperature and partly reused as the liquid mixture of hydrocarbons in the quench step. Another part is discharged as a residue product of the process.

The quenching step is preferably performed in a counter-current operated process step where the gaseous mixture flows upward and the liquid mixture of hydrocarbons flows downwardly. Preferably the counter-current gas-liquid contacting is enhanced by performing the contacting in a packed bed or on one or more distillation trays. Examples of possible distillation trays are bubble cap trays, sieve deck trays, dual flow trays, valve trays and baffle trays.

The resulting gaseous mixture may be cooled to condense to obtain the crude fuel comprising middle distillate fuel fractions. This crude fuel may then be transported to a refinery or the like to isolate the middle distillate fractions, gas oil and kerosene, by distillation. Alternatively, the middle distillate fractions are directly isolated from the gaseous mixture by distillation.

### BRIEF DESCRIPTION OF THE DRAWINGS

FIG. 1 shows an experimental set up used in the examples

FIG. 2 shows a possible reactor configuration of a larger scale process

FIG. 3 shows the vacuum distillation column of FIG. 2 in more detail

### DESCRIPTION OF THE DRAWINGS

The invention shall be illustrated by the following Figures.

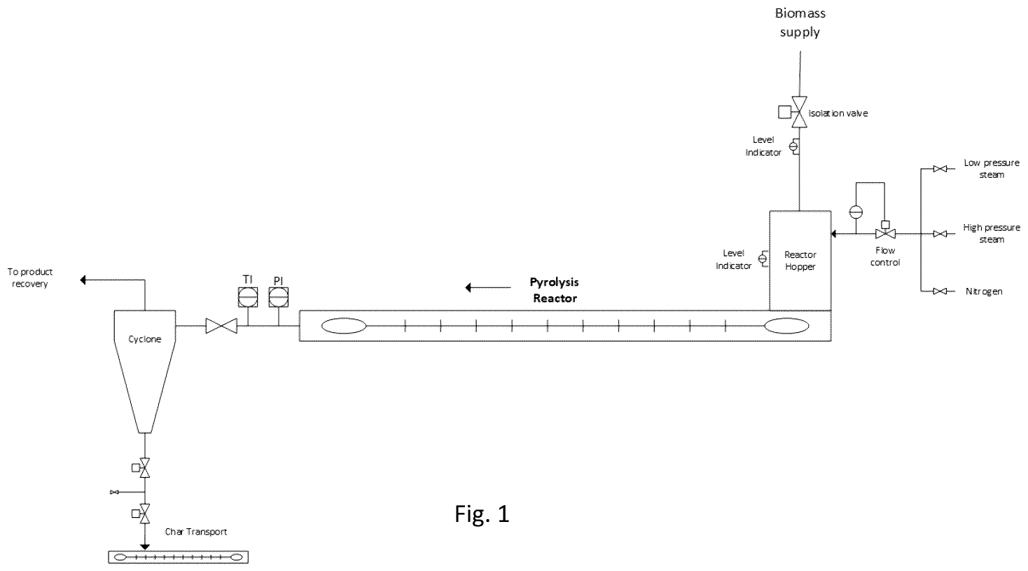

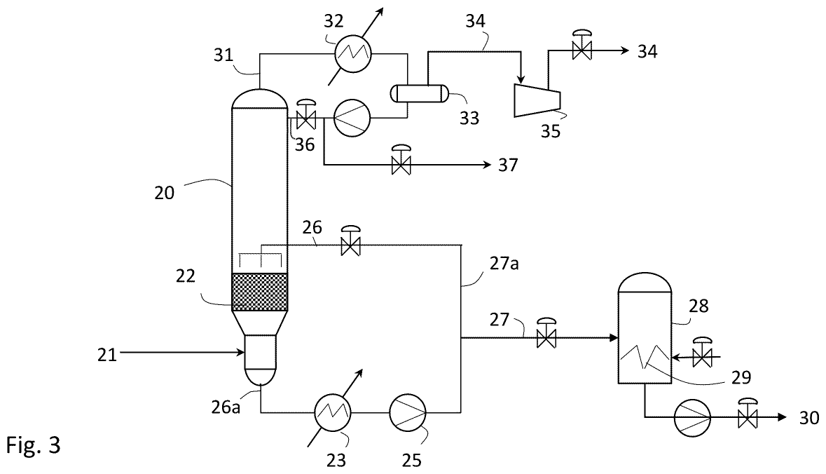

FIG. 1 shows a process scheme of the experimental set up used in the below examples. Dried wood chips are supplied via an isolation valve to a hydrolysis reactor to perform step (a) of the process. This hydrolysis reactor is provided with means to add low pressure steam and low pressure super heated steam to the dried wood chips. The steam saturated wood chips are subsequently moved in an auger reactor, also referred to as the pyrolysis reactor in FIG. 1. In the auger reactor the steam saturated wood chips are moved by an auger driven by an auger motor in one direction. The temperature conditions to perform the pyrolysis of step (b) are achieved by a heating mantle located at the exterior wall of the auger reactor. The pyrolysis reactor is equipped with multi-zoned ceramic heaters which encase the reactor. The heaters provide the capability of providing an ascending, isothermal, or descending reactor temperature profile. At the end of the auger reactor the char particles drop by gravity into a char collection system from which they are removed from the reactor via an isolation valve. The remaining gaseous mixture having an elevated temperature as it is discharged from the auger reactor is further treated by cyclones, to separate any remaining solids and cooled. Commercial scale processes, such as a small scale process, may have the same features as this experimental set up. The crude fuel may be isolated from the gaseous mixture by a distillation process illustrated in FIG. 3.

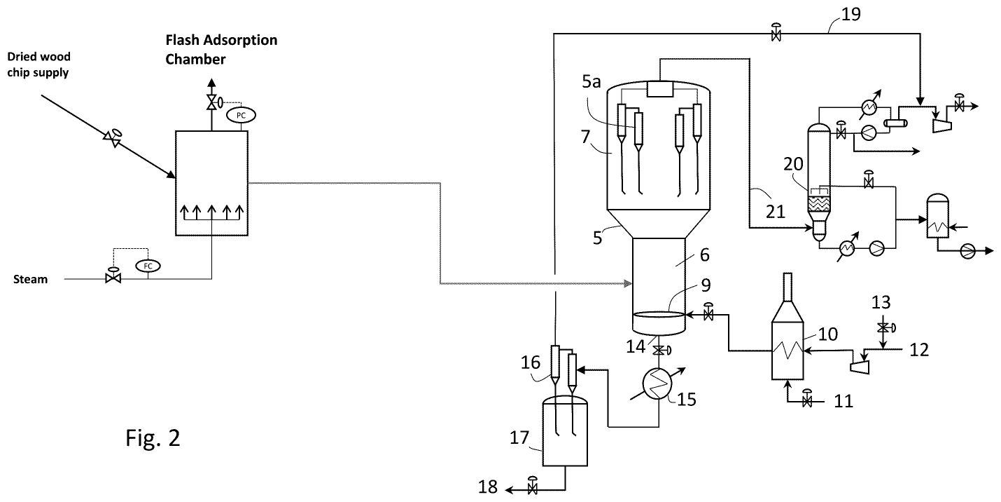

FIG. 2 shows a possible reactor configuration of a larger scale process. Dried wood chips are supplied to a flash adsorption chamber to which steam is supplied. The steam saturated wood chips are supplied to a fluidised bed reactor (5) via conduit (4). The fluidised bed (5) has a lower part (6) and an upper part (7) having a larger diameter than the lower part. In the lower part (6) a bubbling fluidised bed of particles is present. The wider diameter of the upper part (7) will avoid entrainment of particles with the gaseous mixture which is discharged from the bubbling bed of particles. A hydrogen comprising gas is supplied to the fluidised bed via a gas distribution pipe grid (9). The hydrogen comprising gas is heated in a furnace (10) using a fuel gas (11). The fuel gas (11) is preferably isolated from the gaseous overhead stream of the vacuum distillation column (20). The hydrogen comprising gas is made up of hydrogen comprising gas (12) as isolated from the gaseous overhead stream of the vacuum distillation column (20) and make up hydrogen (13).

Char particles are discharged from the fluidised bed reactor (5) at a char particles outlet (14). The hot char particles are cooled in heat exchanger (15) against evaporating boiler feed water generating steam. Any entrained gasses are separated from the cooled char particles in two cyclones (16) wherein the char particles are collected in char collection vessel (17) and discharged as a separate char product (18). The separated gasses are combined with the gaseous overhead stream of the vacuum distillation column (20) via flow (19).

The gaseous mixture is discharged from the fluidised bed reactor (5) via two or more cyclones in series (5a) as present in the upper dome of the reactor vessel of the fluidised bed reactor (5). The separated particles are returned to the fluidised bed in the lower part (6). The gaseous mixture (21) depleted of any entrained particles is supplied to the lower end of a vacuum distillation column (20). which will be described in more detail in FIG. 3.

In FIG. 3 the gaseous mixture (21) is supplied to the lower end of the vacuum distillation column (20). The gaseous mixture will flow upwards and be subjected to a quenching step. The quenching step is performed in a packed bed (22) through which the gaseous mixture flows upwardly and a liquid mixture of hydrocarbons (26) flows counter-currently and thus downwardly. The resulting rich quenching liquid (26a) is cooled in heat exchanger (23) against evaporating boiler feed water and pumped by pump (25) to be partly, as part (27a), used as the liquid mixture of hydrocarbons (26) and partly be discharged via flow (27) to a residue storage vessel (28). In residue storage vessel the residue is heated to avoid solidification by means of indirect steam heater (29). The liquid residue may be discharged from the process via flow (30).

From the upper end of the vacuum distillation column (20) an overhead stream (31) is discharged and cooled in heat exchanger (32) wherein the gas oil fraction condenses. This liquid fraction is separated from the gaseous hydrocarbons boiling below the gas oil range in a gas-liquid separator (33). The overhead gas (34) as obtained and comprising hydrogen, fuel gas compounds and a naphtha fraction and a liquid gas oil fraction is compressed by compressor (35) and sent to a separation train (not shown) wherein for example a liquid naphtha product may be isolated. Part of the liquid gas oil fraction (36) is returned as a reflux stream to the vacuum distillation column (20) and part (37) of the liquid gas oil fraction is obtained as the gas oil product.

As used herein, “contacting” refers to any suitable means for delivering, or exposing, a first material or element to at least a second material or element. In some embodiments, contacting comprises physical human activity, e.g., an injection; an act of dispensing, mixing, and/or decanting; and/or manipulation of a delivery device or machine.

Other than in the operating examples, or where otherwise indicated, all numbers expressing quantities of ingredients or reaction conditions used herein should be understood as modified in all instances by the term “about.” The term “about” when used in connection with percentages can mean ±1%.

As used herein, the term “comprising” means that other elements can also be present in addition to the defined elements presented. The use of “comprising” indicates inclusion rather than limitation. The term “consisting of” refers to compositions, methods, and respective components thereof as described herein, which are exclusive of any element not recited in that description of the embodiment. As used herein the term “consisting essentially of” refers to those elements required for a given embodiment. The term permits the presence of additional elements that do not materially affect the basic and novel or functional characteristic(s) of that embodiment of the invention.

The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The abbreviation, “e.g.” is derived from the Latin exempli gratia, and is used herein to indicate a non-limiting example. Thus, the abbreviation “e.g.” is synonymous with the term “for example.”

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and materials, etc., described herein and as such can vary. The terminology used herein is for the purpose of describing particular embodiments only, and is not intended to limit the scope of the present invention, which is defined solely by the claims.

Other terms are defined herein within the description of the various aspects of the invention.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The invention will be illustrated by the following examples.

### Example 1

To a pyrolysis reactor as shown in FIG. 1 and consisting of a 6.1 m tube having a 10.2 cm inner diameter 225 kg of a feed of biomass chips having average dimensions of 12.5 by 12.5 by 3 mm and at a rate of 3.5 kg/min, was forced through the reactor using as auger. The biomass employed was Southern Yellow Pine (Pinus palustris) which was dried to 7.8 wt % moisture content. The solids residence time in the pyrolysis reactor exceeded 50 seconds. The vapor residence time was less than 15 seconds.

In the hydrolysis reactor saturated steam of 0.86 kPa was injected at a rate of 55 g/min into the dried biomass chips as it was being transported from the rotary air lock to the pyrolysis reactor. The obtained steam saturated biomass was subsequently fed to the upstream end of the pyrolysis reactor as shown in FIG. 1. Because the hydrolysis reactor is directly connected to the pyrolysis reactor the pressure conditions are about the same in both reactors. The hydrolysis reactor was equipped with a steam jacket to prevent condensation of the steam. The temperature at the inlet of the hydrolysis reactor was 50° C. and the outlet temperature was 150° C. where the steam saturated biomass was injected directly into the pyrolysis reactor. The oxygen content was zero.

In the first half of the pyrolysis reactor an isothermal temperature profile of 750° C. was maintained making use of ceramic heaters. The pressure was near vacuum. The second half of the pyrolysis reactor was operated with a descending temperature profile.

At the outlet of the pyrolysis reactor 45 kg char was separated from a gaseous product in a cyclone. The gaseous product was condensed to an orange-red liquid fuel with an initial boiling point of 0° C. and a final boiling point of 647° C. Approximately 60 wt % boiled in the diesel range and approximately 30 wt % boiled in the gas oil range. The quality of the fuel was such that it may be used as middle distillate fuel. The true boiling points of the liquid product are presented in Table 1.

TABLE 1

| TBP | ° C. |
|---|---|
| IBP | 0 |
| 2 | 185 |
| 5 | 198 |
| 10 | 210 |
| 20 | 236 |
| 30 | 255 |
| 50 | 311 |
| 70 | 393 |
| 90 | 510 |
| 95 | 546 |
| 98 | 585 |
| FBP | 647 |

### Comparative Experiment A

Example 1 was repeated except that no steam was added in the hydrolysis reactor. A primarily a thick, black, viscous residue was obtained after separating a char which residue had an initial TBP boiling point of 136° C. and a final boiling point of 612° C. The fuel had little commercial value.

This shows that the steam injection as in Example 1 influenced the pyrolysis reaction such that the quality of the fuel produced was dramatically improved.

### Example 2

Example 1 was repeated except that now 1000 kg of the dried biomass chips were converted. 410 Liters of a liquid product was obtained. The quality of the liquid products was comparable to the quality of the liquid product obtained in Example 1.

This example shows that when processing more biomass a higher liquid product yield is achievable.

### Example 3

Example 2 is repeated except that the steam injection rate was 110 g/min. 543 Liters of a liquid product was obtained. The quality of the liquid products was comparable to the quality of the liquid product obtained in Example 1. This example shows that the yield to liquid product may be improved by injecting more steam.

### Example 4

Example 2 was repeated except that in the first half of the pyrolysis reactor an isothermal temperature profile of 685° C. was maintained. 270 Liters of a liquid product was obtained. The quality of the liquid products was comparable to the quality of the liquid product obtained in Example 1.

### Example 5

Example 4 was repeated except that the steam injection rate was 110 g/min. 391 Liters of a liquid product was obtained. The quality of the liquid products was comparable to the quality of the liquid product obtained in Example 1.

### Example 6

Example 4 was repeated except that the steam injection rate was 165 g/min. 227 liters of a liquid product was obtained. The quality of the liquid products was comparable to the quality of the liquid product obtained in Example 1.

Example 4-6 indicated that there is an optimum steam injection at a reactor temperature of 685° C. at approximately 110 g/min.

### Example 7

Example 1 was repeated except that 225 kg of wood shavings was used as feed. The wood shavings were the thin wood chips that result from planing lumber. The shavings had a moisture content of 7.5 wt %. The steam injection rate was 33 g/min. In the first half of the pyrolysis reactor an isothermal temperature profile of 650° C. was maintained. 90 Liters of a liquid product was obtained. The quality of the liquid products was comparable to the quality of the liquid product obtained in Example 1.

### Comparative Experiment B

Example 2 was repeated except that the biomass chips of the Southern Yellow Pine (Pinus palustris) was not dried and thus had a moisture content of 45 wt %. No steam was injected.

This test was carried out to determine whether the positive benefit of the steam injection was a result of injection after the drying process or was simply due to the water content.

The test was terminated after injection of the first 100 kg of biomass due to the ceramic heaters being unable to reach the reactor temperature setpoint and no fuel being produced.

This test failed due to the ceramic heaters having insufficient power to reach the pyrolysis temperature. The energy demand was significantly greater than with dried biomass, making clear that even if this test had been successful the processing of green biomass is non-economic.

What is claimed herein is:

1. A process to convert a solid biomass to a crude fuel comprising middle distillate fuel fractions, the process comprising:
(a) contacting the solid biomass having a water content of below 20 wt % with steam for more than 10 seconds at pressurised conditions to obtain steam saturated biomass and
(b) subjecting the steam saturated biomass to a pyrolysis step at a temperature of between 600 and 800° C. to obtain the crude fuel comprising the middle distillate fuel fractions.

2. The process according to claim 1, wherein the solid biomass is a woody biomass.

3. The process according to claim 2, wherein the woody biomass is a flow of saw dust, shavings, wood chips or pellets and wherein more than 85 wt % of the saw dust, shavings, chips or pellets have a largest dimension less than 2 cm.

4. The process according to claim 3, wherein the woody biomass is a flow of saw dust, shavings, wood chips or pellets and wherein more than 85 wt % of the chips or pellets have a largest dimension less than 1 cm.

5. The process according to claim 1, wherein in step (a) the solid biomass is contacted between 0.5 minutes and 30 minutes with steam having a pressure of at least 0.031 MPa.

6. The process according to claim 1, wherein the contacting in step (a) is performed at a pressure of below 1.4 MPa.

7. The process according to claim 1, wherein step (b) is performed at a pressure of between 0.7 kPa and 35 kPa.

8. The process according to claim 6, wherein step (b) is performed at a pressure of between 3.0 kPa and 15 kPa.

9. The process according to claim 1, wherein the steam saturated biomass obtained in step (a) is directly subjected to the pyrolysis step of step (b) after performing step (a).

10. The process according to claim 1, wherein in step (b) is performed continuously at a temperature of between 625 and 700° C. and at a solids residence time of between 30 and 120 seconds.

11. The process according to claim 1, further comprising isolating a gas oil fraction and a kerosene fraction from the crude fuel by distillation.

12. The process according to claim 1, wherein step (b) is performed in an auger reactor.

13. The process according to claim 12, wherein at the downstream end of the auger reactor char particles are separated from a gaseous mixture comprising the crude fuel comprising the middle distillate fuel fractions.

14. The process according to claim 1, wherein step (b) is performed in a fluidised bed reactor.

15. The process according to claim 14, wherein fluidised bed reactor comprises a bubbling fluidising bed of the steam saturated biomass wherein a fluidising gas is supplied to the bubbling fluidising bed and wherein a gaseous mixture comprising the crude fuel comprising middle distillate fuel fractions is discharged from the fluidising bed.

16. The process according to claim 15, wherein the char particles are discharged from the bubbling fluidising bed and separately a gaseous mixture comprising the crude fuel.

17. The process according to claim 15, wherein the gaseous mixture comprising the crude fuel comprising middle distillate fuel fractions has an elevated temperature and is upflowing as it is discharged from the fluidised bed reactor, and
wherein the gaseous mixture comprising the crude fuel comprising middle distillate fuel fractions having an elevated temperature is quenched with a liquid mixture of hydrocarbons having a lower temperature than the gaseous mixture comprising the crude fuel comprising middle distillate fuel fractions having an elevated temperature by counter-currently contacting the liquid mixture of hydrocarbons with the upflowing gaseous mixture comprising the crude fuel comprising middle distillate fuel fractions having an elevated temperature.

18. A process to convert a solid biomass to a crude fuel comprising middle distillate fuel fractions by performing the following steps:
(a) contacting s solid biomass having a water content of below 20 wt % with steam to obtain a steam saturated biomass;
(b) directly subjecting the steam saturated biomass to a pyrolysis step at a temperature of above 600° C. for a period of at least 30 seconds and at a pressure of between 0.7 kPa and 35 kPa to obtain a solid char and a crude fuel; and
(c) separating the solid char from the crude fuel.

19. The process according to claim 18, wherein step (b) is performed at a pressure of between 3.0 kPa and 15 kPa.

20. The process according to claim 18, wherein in step (b) is performed continuously at a temperature of between 625 and 700° C. and at a solids residence time of between 30 and 120 seconds.

21. The process according to claim 18, wherein from the crude fuel a gas oil fraction and a kerosene fraction is isolated by distillation.

22. The process according to claim 18, wherein the solid biomass is composed of saw dust, shavings, wood chips or dried wood pellets and wherein more than 85 wt % of the chips or pellets have a largest dimension of less than 1 cm.

23. The process according to claim 22, wherein step (b) is performed in a fluidised bed reactor comprising a bubbling fluidising bed of the steam saturated biomass;
wherein a fluidising gas is supplied to the bubbling fluidising bed; and
wherein a gaseous mixture comprising the crude fuel comprising middle distillate fuel fractions is discharged from the bubbling fluidising bed.
